(19) United States
(12) Patent Application Publication
(10) Pub. No.: US 2015/0202845 A1
(43) Pub. Date: Jul. 23, 2015

(54) MULTI-LAYER TRANSPARENT LIGHT-WEIGHT SAFETY GLAZINGS

(71) Applicant: CORNING INCORPORATED, CORNING, NY (US)

(72) Inventors: Sarko Cherekdjian, Campbell, CA (US); Charles Mitchel Sorensen, JR., Haverstraw, NY (US)

(21) Appl. No.: 14/418,982

(22) PCT Filed: Aug. 1, 2013
(86) PCT No.: PCT/US13/53219

§ 371 Date: Feb. 2, 2015

Related U.S. Application Data
(60) Provisional application No. 61/679,330, filed on Aug. 3, 2012.

(51) Int. Cl. B32B 17/10

(52) U.S. Cl. CPC B32B 17/10045; B32B 17/10743; B32B 17/10761; B32B 17/1077; B32B 17/10788; B32B 17/10137; B32B 2571/02; B32B 2250/42

(57) ABSTRACT

A multi-layer glass structure is provided having n layers of annealed or chemically strengthened glass and n−1 layers of a polymer interlayer where n is a positive integer greater than 2. In another embodiment, a glass laminate structure is provided having a plurality of annealed or chemically strengthened glass sheets, one or more polymeric interlayers positioned between adjacent annealed or chemically strengthened glass sheets, and a thin annealed or chemically strengthened glass sheet on a first side of the glass laminate structure.

### CROSS REFERENCES

The present application is co-pending with and claims the priority benefit of the provisional application entitled, “Multi-layer Transparent Light-weight Safety Glazings,” Application Ser. No. 61/679,330, filed on Aug. 3, 2012 the entirety of which is incorporated herein by reference.

### BACKGROUND

Safety glazing and ballistic resistant glazing (BRG) are classes of optically transparent window products designed to protect occupants of buildings, transport vehicles, etc., from penetration by projectiles such as, but not limited to, windblown objects, bullets, and the like. In exemplary window products, the outside surface of the window pane, the face receiving the incoming projectile, is generally referred to as the “strike face,” and the innermost surface of the window pane closest to the occupants of the building, vehicle, etc., is referred to as the “witness side.”

BRG products are typically constructed from several layers of glass and/or plastics or polymers. Conventional glass materials used for ballistic laminates include soda lime glass and borosilicate glass which are typically manufactured using a float process. Other conventional glass materials used for ballistic laminates include crystalline materials such as aluminum oxy-nitride (ALON), spinel, sapphire, and glass-ceramic materials (GC). Multiple glass and/or plastic layers are typically bonded together in a lamination process using polymeric or adhesive interlayer materials to form a BRG window pane. Conventional BRG window panes are very thick and heavy, and the overall thickness, number of glass, plastic, and/or interlayer sheets, and the specific weight (e.g. mass per unit area) of the construction can be varied to resist various threat levels. These threat levels are generally a function of the type of projectile, the mass of the projectile and its construction, and velocity obtained from the explosive charge in the respective cartridge as well as the impact of one or more projectiles (typically three projectiles) within a predetermined area (e.g., 4.5 inch triangle).

Threat levels are characterized by standard ballistic tests defined by various organizations such as the National Institute of Justice in the United States. Widely accepted ballistic resistance testing requirements in the United States include the Underwriters Laboratories (UL) 752, the National Institute of Justice Standard 0108.01, and the American Standards Testing Methods (ASTM) F1233. These requirements and associated tests evaluate ballistic impacts from various weapons in single and multiple shot sequences. Some testing standards allow for an accepted amount of spall, the emission of glass from the witness side regardless of projectile penetration, whereas other testing standards do not. International ballistic standards are also present to reflect common types of ballistic threats present in a respective geographic region. Exemplary international ballistic standards include the European Standard (EN) 1063: 1999 Security Glazing Ballistic Standard.

Soda lime glass produced by a float process is commonly employed in conventional BRG constructions. Conventional BRG window constructions range in materials and constructions such as all glass (e.g., annealed), all polymeric (e.g., all acrylic, polycarbonate, or combinations thereof), or a combination of glass and polymeric layers. A summary of conventional BRG constructions produced commercially with their relative thicknesses and weights per UL 782 threat levels 1 to 3 are listed in Table 1 below.

TABLE 1

| | Level 1 | | Level 2 | | Level 3 | |
|---|---|---|---|---|---|---|
| | | Wt | | Wt | | Wt |
| Construction | T (in) | (lb/ft2) | T (in) | (lb/ft2) | T (in) | (lb/ft2) |
| Acrylic sheet | 1.25 | 7.7 | 1.375 | 8.5 | | |
| Poly/Acrylic/Poly | 0.75 | 4.6-5.1 | 0.875-1.03 | 5.4-6.4 | 1.25 | 7.7-8.1 |
| laminates | | | | | | |
| Polycarbonate laminates | 0.75 | 5.1 | 1-1.03 | 6.4-6.5 | 1.313 | 8.1 |
| Glass Clad | 0.75-0.818 | 7.14-8.99 | 0.94-1.075 | 10.34-11.68 | 1.125 | 12.19 |
| Polycarbonates | | | | | | |
| All Glass laminates | 1.2-1.2188 | 14.71 | 1.5-1.875 | 17.94-21.11 | 1.75 | 26 |
| Glass/Acrylic/Poly- | | | 0.81-0.94 | 4.3-5.7 | 1.063 | 6.3 |
| carbonate laminates | | | | | | |
| Air gap dual glass | 0.875-1 | 6.3-8.5 | 1.125 | 8.7 | 1.25 | 10 |
| Polycarbonate laminates | | | | | | |
| DuPont multilayers | 0.85 | 9.1 | 0.88 | 9.17 | 1 | 10.7 |

Each conventional BRG construction has its advantages and disadvantages depending upon the respective constituent layers. For example, all glass constructions are generally durable (not susceptible to scratching or UV attack) and are clear with little visual distortion; however, all glass constructions are heavy and are generally the thickest constructions. Acrylic constructions are relatively light but are not durable or optically clear without distortion and are typically only available for UL 752 threat levels 1 and 2. Furthermore, acrylic layers are brittle under ballistic impact. Glass clad polycarbonate structures are generally lighter than all glass but suffer from optical visual distortions, and the polycarbonate layer is easily scratched. Thus, the polycarbonate layer is usually treated with an anti-scratch surface coating if exposed on a surface of the respective laminate structure. Furthermore, an additional UV coating is applied to stop detrimental yellowing of the polycarbonate material occurring with prolonged exposure to UV rays. Such coatings generally increase the expense of polycarbonate-based BRG constructions. It should also be noted that conventional acrylic and polycarbonate layers are susceptible to chemical degradation, e.g., methanol, toluene, acetone, methylene chloride, and gasoline. Defects caused by such chemical degradation range from cracking to tacky surfaces and/or sheer layer destruction, each of which negatively affects optical transparency and threat protection performance of a respective window pane.

### SUMMARY

Embodiments of the present disclosure are generally directed to a multi-layer laminated transparent safety glass. Some embodiments of the present disclosure provide a laminated transparent safely glass structure having a plurality (e.g., 5 to 20 layers or more) of thin chemically strengthened glass layers having a thickness of approximately 1 mm or greater.

In additional embodiments of the present disclosure, it was discovered that multi-layer laminate BRG window panes made from numerous layers of relatively thin glass with or without chemical strengthening (CS) having transparent PVB interlayers results in windows with higher transparency, lower weight, and thinner profiles than conventional BRG window structures formed from soda lime glass and/or glass and plastic layers at equivalent threat protection levels. Additionally, exemplary embodiments of the present disclosure may be utilized as the strike face to new window constructions as described herein or existing BRG constructions that wish to benefit from the increased threat level improvement and the weight reduction that exemplary embodiments can provide. In addition, chemically strengthened glass layers provide a mechanism to make the BRG composite structure optically opaque after an initial first projectile impact, thus hiding the occupants from directed projectiles. Annealed or thermally tempered glass does not provide this additional level of protection.

In a further embodiment of the present disclosure, a plurality of layers of CS glass and polymeric interlayer materials may be employed as a strike face element of a new window construction or provided on an existing BRG construction.

In some embodiments of the present disclosure, multi-layer CS glass laminations may be made with either single glass composition layers or layers comprising different combination of various glasses, e.g., CORNING EagleXG or Gorilla® Glass. In other embodiments of the present disclosure, an exemplary window structure may include CS glasses having different glass compositions in different layers of the respective laminate, may include additional thin glass layers in the laminate than typically used in BRG constructions, may include different CS glass thicknesses in the laminate, may include different levels of chemical strengthening in some or all the layers of the laminate, and/or may include different soft and/or hard interlayers in different layers of the laminate.

Embodiments of the present disclosure may thus provide improvements in threat levels for BRG laminates, weight and thickness reductions, ultra-clear multiple laminations utilizing clear interlayers (such as DuPont SentryGlas® N-UV), and/or reductions in green/yellow color present in conventional BRG laminates which employ interlayers such as Solutia RA41 or DuPont SentryGlas® between layers of soda-lime glass.

Embodiments of the present disclosure may find utility through use of laminations of transparent CS glass for various armor systems including, but not limited to, armor systems for ground vehicles and aircraft, personal protective devices and the like. Optical properties for such armor systems may be visibly transparent and may also be near-IR transparent and achieve moderate density combined with higher ballistic limits. Additional embodiments of the present disclosure may also provide bonding materials, interlayer materials, adhesive and/or polymer materials which substantially match the refractive index of CS glass to ensure optimum optical performance. In some embodiments the adhesive and polymeric material may be transparent to infrared radiation.

In one embodiment, a laminate structure is provided having a plurality of glass layers, and at least one polymer interlayer intermediate adjacent glass layers, where each of the plural glass layers comprise thin, annealed (such as Corning EagleXG) or chemically strengthened glass (such as the Corning family of Gorilla glass). In another embodiment, a glass laminate structure is provided having a plurality of annealed or chemically strengthened glass sheets and one or more polymeric interlayers positioned between adjacent chemically strengthened glass sheets. In an additional embodiment, a multi-layer glass structure is provided having n layers of annealed or chemically strengthened glass and n−1 layers of a polymer interlayer.

### BRIEF DESCRIPTION OF THE DRAWINGS

FIG. 1 is a cross section of one embodiment of the present disclosure.

FIG. 2 is a cross section of another embodiment of the present disclosure.

FIGS. 3A-3D are schematics of some embodiments of the present disclosure.

FIG. 4 is a graphical illustration comparing the transparency of Corning Gorilla® Glass to soda lime glass.

FIG. 5 is a graphical illustration comparing the transparency of Corning Gorilla® Glass laminated with transparent PVB interlayers to Corning Gorilla® Glass laminated with standard PVB interlayers.

FIG. 6 is a graphical illustration comparing ballistic impact resistances of embodiments of the present disclosure.

### DETAILED DESCRIPTION

With reference to the figures, where like elements have been given like numerical designations to facilitate an understanding of the present disclosure, the various embodiments for multi-layer transparent light-weight safety glazings are described.

The following description of the present disclosure is provided as an enabling teaching thereof and its best, currently-known embodiment. Those skilled in the art will recognize that many changes can be made to the embodiment described herein while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations of the present disclosure are possible and may even be desirable in certain circumstances and are part of the present disclosure. Thus, the following description is provided as illustrative of the principles of the present disclosure and not in limitation thereof.

Those skilled in the art will appreciate that many modifications to the exemplary embodiments described herein are possible without departing from the spirit and scope of the present disclosure. Thus, the description is not intended and should not be construed to be limited to the examples given but should be granted the full breadth of protection afforded by the appended claims and equivalents thereto. In addition, it is possible to use some of the features of the present disclosure without the corresponding use of other features. Accordingly, the foregoing description of exemplary or illustrative embodiments is provided for the purpose of illustrating the principles of the present disclosure and not in limitation thereof and may include modification thereto and permutations thereof.

It is generally recognized that a material's hardness and fracture toughness contribute to its ballistic performance, although the exact correlation between static material properties and ballistic performance is still under research. One hypothesis is that an ideal ballistic armor material should have sufficient hardness to break up a projectile. Above a certain threshold hardness value, however, hardness no longer dictates performance. Thus, if optimization of other mechanical properties such as fracture toughness are achieved while the hardness is above the threshold value, ballistic armor performance can be optimized as in embodiments described herein.

Thin annealed or chemically strengthened (CS) glass is a thin, hard, fracture resistant transparent material. As described in U.S. Pat. Nos. 7,666,511, 4,483,700 and 5,674,790, the disclosures of which are each incorporated herein in their entirety, Corning Gorilla® Glass is a CS glass made by fusion drawing a glass sheet and then chemically strengthening the glass sheet. Corning Gorilla® Glass possesses a relatively deep depth of layer (DOL) of compressive stress and provides surfaces having a relatively high flexural strength, high scratch resistance and high impact resistance.

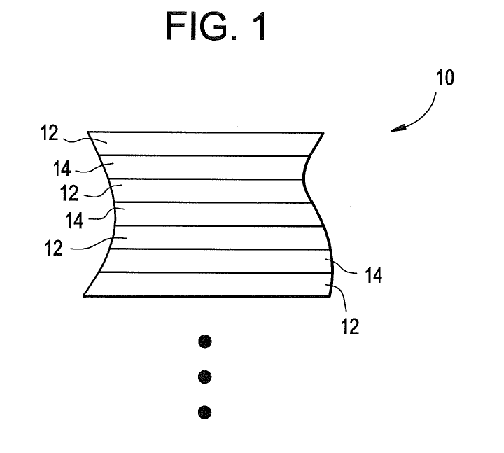

FIG. 1 is a cross section of one embodiment of the present disclosure. With reference to FIG. 1, an all CS glass BRG structure 10 or more laminate structure is illustrated having a plurality of thin CS glass sheets 12 laminated together with a standard transparent polyvinyl butyral (PVB) interlayer 14 between adjacent pairs of CS glass sheets 12. In a non-limiting embodiment, lamination may be performed by a vacuum ring or vacuum bag de-air and tack lamination processes. In an alternative embodiment, a polycarbonate layer may be included on the witness side of the laminate structure to provide an anti-spalling layer. In another embodiment, the strike face of the laminate structure may be formed of a thin CS glass. Exemplary interlayers may be comprised of, but not limited to, polyvinyl butyral (PVB), polycarbonate, acoustic PVB, ethylene vinyl acetate (EVA), thermoplastic polyurethane (TPU), ionomer (such as SentryGlas® from DuPont), or other suitable polymers or thermoplastic materials and combinations thereof. In some embodiments, one or more of the glass layers may be chemically strengthened, tempered or heat strengthened and placed at the strike face. In other embodiments of the present disclosure, the glass sheets 12 may be made with either single glass composition layers or layers comprising different combination of various glasses, e.g., CORNING EagleXG, or CORNING Gorilla® Glass. In other embodiments of the present disclosure, an exemplary window structure may include CS glasses having different glass compositions in different layers of the respective laminate, may include additional thin glass layers in the laminate than typically used in BRG constructions, may include different CS glass thicknesses in the laminate, may include different levels of chemical strengthening in some or all the layers of the laminate, and/or may include different soft and/or hard interlayers in different layers of the laminate.

The term “thin” as used in relation to the glass sheets in the present disclosure and the appended claims means glass sheets having a thickness not exceeding 1.5 mm, not exceeding 1.0 mm, not exceeding 0.7 mm, not exceeding 0.5 mm, or within a range from about 0.5 mm to about 1.0 mm, from about 0.5 mm to about 2 mm, or from about 0.5 mm to about 0.7 mm.

Exemplary CS glass sheets may be formed of thin glass sheets chemically strengthened using an ion exchange process, such as Corning Gorilla® Glass from Corning Incorporated. In this type of process, the glass sheets are typically immersed in a molten salt bath for a predetermined period of time. Ions within the glass sheet at or near the surface of the glass sheet are exchanged for larger metal ions, for example, from the salt bath. In one non-limiting embodiment, the temperature of the molten salt bath is about 430° C. and the predetermined time period is about eight hours. Incorporation of the larger ions into the glass generally strengthens the sheet by creating a compressive stress in a near-surface region of the glass. A corresponding tensile stress may also be induced within a central region of the glass sheet to balance the compressive stress.

An exemplary vacuum ring laminating process may include assembling a plurality of thin glass sheets and a plurality of polymer interlayers into a stack. A vacuum ring may then be clamped around the peripheral edge portion of the assembled stack to form a seal for applying a vacuum to the peripheral edges of the assembled stack. The clamped, assembled stack may then be placed into an autoclave or oven and a vacuum drawn via a vacuum tube on the vacuum ring. The temperature in the autoclave may then be elevated to a temperature that is at or somewhat above the softening temperature of the polymer interlayer (the soak temperature). The interlayer may be softened by maintaining the vacuum and soak temperature. Furthermore, any space between adjacent glass sheets may thus be de-aired and the softened interlayers may be bonded or tacked between the CS glass sheets to thereby laminate the assembled stack together forming an exemplary laminated structure. Upon completion of this lamination process, the laminated assembly or structure may be removed from the autoclave and the vacuum ring separated from the stack. Exemplary resulting laminates will generally be clear or substantially clear; however, if necessary, the laminate may be autoclaved at an elevated temperature and pressure to complete and/or clarify the laminate. In an alternative embodiment, a similar time/temperature regime can be used for a vacuum bag laminating processes rather that the previously described vacuum ring process. While some embodiments may be laminated in an autoclave, such a disclosure should not limit the scope of the claims appended herewith especially in cases where it is unnecessary to pressurize the chamber in which the assembled structure is being laminated due to the thin and flexible nature of the thin CS glass sheets. In such a case, a more economical oven equipped with vacuum ports to draw a vacuum in the vacuum ring or vacuum bag may be employed in place of an autoclave.

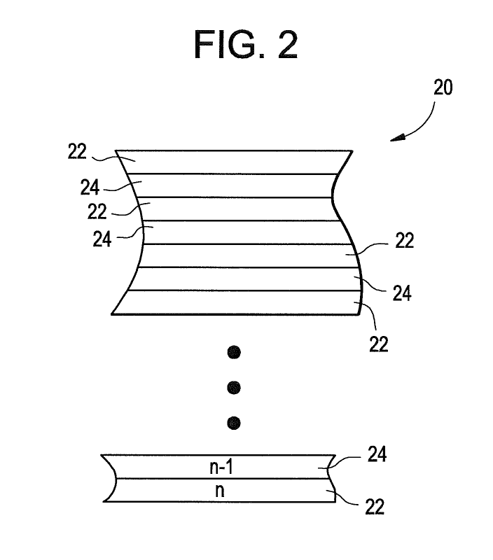

FIG. 2 is a cross section of another embodiment of the present disclosure. With reference to FIG. 2, a multi-layer structure 20 may include n layers of glass 22, e.g., 5, 10, 15, 20, etc., and n−1 layers of an exemplary polymer interlayer 24. In some embodiments, the polymer interlayer may be PVB. Other exemplary interlayers may be, but not limited to, PVB, polycarbonate, acoustic PVB, EVA, TPU, ionomer (such as SentryGlas® from DuPont), or other suitable polymers or thermoplastic materials and combinations thereof. Exemplary glass layers 22 may include, but are not limited to, Gorilla® Glass CS glass. In another embodiment, the strike face of the multi-layer structure 20 may be formed of a thin CS glass. In some embodiments, one or more of the glass layers may be chemically strengthened, tempered or heat strengthened and/or placed at the strike face. In other embodiments of the present disclosure, the glass layers 22 may be made with either single glass composition layers or layers comprising different combination of various glasses, e.g., CORNING Eagle XG, or CORNING Gorilla® Glass. In additional embodiments of the present disclosure, an exemplary multi-layer structure may include CS glasses having different glass compositions in different layers of the respective laminate, may include additional thin glass layers in the laminate than typically used in BRG constructions, may include different CS glass thicknesses in the laminate, may include different levels of chemical strengthening in some or all the layers of the laminate, and/or may include different soft and/or hard interlayers in different layers of the laminate. Table 2 provided below provides a tabular demonstration of the properties of exemplary, non-limiting Gorilla® Glass CS glass multi-layer constructions according to embodiments of the present disclosure.

TABLE 2

| Laminate | | | | | | |
|---|---|---|---|---|---|---|
| structure (n | | | | Total | | |
| CS glass + | Total | | | surface | | |
| (n-1) | thickness | Length | Width | area | Total | Lbs/ |
| interlayer) | (mm) | (in) | (in) | (sqin) | Weight | sqft |
| 5*1 mm + | 8.04 | 4.4375 | 6.875 | 30.508 | 0.6725 | 3.174 |
| 4*0.76 mm | | | | | | |
| 10*1 mm + | 16.84 | 4.4375 | 6.875 | 30.508 | 1.38 | 6.514 |
| 9*0.76 mm | | | | | | |
| 15*1 mm + | 25.64 | 4.4375 | 6.875 | 30.508 | 2.0885 | 9.858 |
| 14*0.76 mm | | | | | | |
| 20*1 mm + | 34.44 | 4.4375 | 6.875 | 30.508 | 2.793 | 13.18 |
| 19*0.76 mm | | | | | | |
| 20*1 mm + | 34.44 | 6 | 6 | 36 | 3.236 | 12.94 |
| 19*0.76 mm | | | | | | |

Table 3 provided below provides a tabular demonstration of the properties of standard conventional all glass and glass clad polycarbonate BRG constructions at UL 752 threat levels of 1 to 3.

TABLE 3

| | Total | | | | Total | | |
|---|---|---|---|---|---|---|---|
| | thick- | | | | surface | Total | |
| | ness | | Length | Width | area | Weight | Lbs/ |
| | (mm) | Layers | (in) | (in) | (sqin) | (lbs) | sqft |
| All Glass | | | | | | | |
| Level 1 | 32.15 | 4 | 12 | 12 | 144 | 15.8 | 15.8 |
| Level 2 | 45 | 6 | 12 | 12 | 144 | 21.5 | 21.5 |
| Level 3 | 53.4 | 6 | 12 | 12 | 144 | 26.1 | 26.1 |
| Glass Clad | | | | | | | |
| Poly- | | | | | | | |
| carbonate | | | | | | | |
| Level 1 | 17.2 | 3 | 12 | 12 | 144 | 7.1 | 7.1 |
| Level 2 | 24 | 3 | 12 | 12 | 144 | 10.65 | 10.65 |
| Level 3 | 26.5 | 4 | 12 | 12 | 144 | 12.1 | 12.1 |

Comparing the values exhibited in Tables 2 and 3, the properties of various all CS glass multi-layer constructions in embodiments of the present disclosure having n layers of glass and n−1 layers of polymer interlayers provide both thickness and weight reduction advantages over conventional all glass and glass clad polycarbonate constructions.

Table 4 below provides a tabular demonstration of the dimensional and weight reductions for exemplary embodiments of the present disclosure.

TABLE 4

| | Level 1 | | | | Level 2 | | | | Level 3 | | | |
|---|---|---|---|---|---|---|---|---|---|---|---|---|
| | Compare to | | Compare to | | Compare to | | Compare to | | Compare to | | Compare to | |
| All Gorilla | All Glass | | All GCP | | All Glass | | All GCP | | All Glass | | All GCP | |
| Glass | Thk | Wt | Thk | Wt | Thk | Wt | Thk | Wt | Thk | Wt | Thk | Wt |
| Laminates | Adv | Adv | Adv | Adv | Adv | Adv | Adv | Adv | Adv | Adv | Adv | Adv |
| 5*1 mm + | 74.99% | 79.91% | 53.26% | 55.29 | 82.13% | 85.24% | 66.50% | 70.19% | 84.94% | 87.84% | 69.66% | 73.77% |
| 4*0.76 mm = | | | | | | | | | | | | |
| 8.04 | | | | | | | | | | | | |
| 10*1 mm + | 47.62% | 58.77% | 2.09% | 8.26% | 62.58% | 69.70% | 29.83% | 38.84% | 68.46% | 75.04% | 36.45% | 46.17% |
| 9*0.76 mm = | | | | | | | | | | | | |
| 16.84 | | | | | | | | | | | | |
| 15*1 mm + | 20.25% | 37.61% | −49.07% | −38.84% | 43.02% | 54.15% | −6.83% | 7.44% | 51.99% | 62.23% | 3.25% | 18.53% |
| 14*0.76 mm = | | | | | | | | | | | | |
| 25.64 | | | | | | | | | | | | |
| 20*1 mm + | −7.12% | 16.56% | −100.23% | −85.68% | 23.47% | 38.68% | −43.50% | −23.79% | 35.51% | 49.49% | −29.96% | −8.95% |
| 19*0.76 mm = | | | | | | | | | | | | |
| 34.44 | | | | | | | | | | | | |
| 20*1 mm + | −7.12% | 18.08% | −100.23% | −82.31% | 23.47% | 39.80% | −43.50% | −21.54% | 35.51% | 50.41% | −29.96% | −6.98% |
| 19*0.76 mm = | | | | | | | | | | | | |
| 34.44 | | | | | | | | | | | | |

With reference to Table 4 above, it is demonstrated that a 10 layer Gorilla® Glass CS glass lamination provides a weight enhancement from level 1 to 3 for both standard all glass and glass clad polycarbonate constructions. Embodiments having a 15 layer Gorilla® Glass CS glass lamination provide a weight advantage from threat level 1 to level 3 for standard all glass constructions but only level 2 to 3 for glass clad polycarbonate constructions.

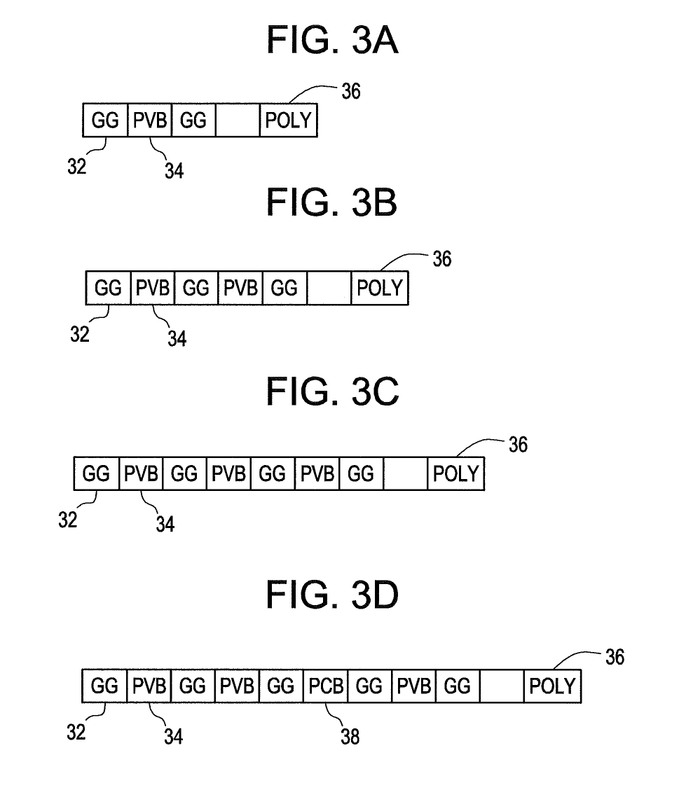

FIGS. 3A-3D are cross sections of additional embodiments of the present disclosure. With reference to FIGS. 3A-3D, exemplary CS glass clad polycarbonate construction structures 30 are illustrated having a first plurality of Gorilla® Glass CS glass layers 32 and one or more PVB interlayers 34. As depicted, a polycarbonate layer 36 may be included on the witness side of the structure 30 to provide an anti-spalling layer. In other embodiments, one or more of the PVB interlayers 34 may be substituted with a polycarbonate interlayer 38 as depicted in FIG. 3D. In a further embodiment, a PVB interlayer may be located between each adjacent CS glass sheet and polycarbonate sheet/interlayer. In yet a further embodiment, the strike face of the laminate structure may be formed of a thin CS glass. In another embodiment, the strike face of the laminate structure may be formed of a thin CS glass. Exemplary interlayers may be comprised of, but not limited to, PVB, polycarbonate, acoustic PVB, EVA, TPU, ionomer (such as SentryGlas® from DuPont), or other suitable polymers or thermoplastic materials and combinations thereof. In some embodiments, one or more of the glass layers may be chemically strengthened, tempered or heat strengthened and placed at the strike face. In other embodiments of the present disclosure, the glass layers 32 may be made with either single glass composition layers or layers comprising different combination of various glasses, e.g., CORNING Gorilla® Glass. In other embodiments of the present disclosure, an exemplary structure 32 may include CS glasses having different glass compositions in different layers of the respective laminate, may include additional thin glass layers in the laminate than typically used in BRG constructions, may include different CS glass thicknesses in the laminate, as illustrated in FIGS. 3A-3D, may include different levels of chemical strengthening in some or all the layers of the laminate, and/or may include different soft and/or hard interlayers in different layers of the laminate.

Embodiments of the present disclosure having thin CS glass are lighter than all-glass BRG constructions of the same thickness and exhibit better optical transparency. Such thickness and weight reduction of glass laminates according to embodiments of the present disclosure translate to lower requirements in frame and mounting structures, improved optical transparency and aesthetics, lower installation costs, and increased power to weight ratio when employed in vehicles. Furthermore, thin multi-layer CS glass embodiments provide more glass interfaces than available in current BRG construction thereby providing an enhanced protection due to an increased “interface defeat” presented to a projectile. Interface defeat generally refers to kinetic energy dissipation of a projectile upon its encounter of alternating layers of hard and soft material in the pathway of the projectile. Energy is dissipated by transfer to recoiling glass fragments, stretching, and viscoelastic effects into the polymer interlayers, and through heat and vibration in the entire window and surrounding frame.

It has also been found that the use of Gorilla® Glass or CS glass compositions that do not densify (i.e., do not increase in material density and compress upon impact) rather than densify or increase the level of protection provided. In one experiment, two different laminate composites were subject to projectile impacts whereby it was observed that one exemplary embodiment having a first predetermined Gorilla® Glass composition (20 1 mm glass sheets laminated with 19 sheets of 0.76 mm RA41 PVB) resulted in two layers rupturing where a second predetermined Gorilla® Glass composition (also having 20 1 mm glass sheets laminated with 19 sheets of 0.76 mm RA41 PVB) resulted in five layers rupturing for the same impact rating. In another experiment, a 15 layer Gorilla® Glass composite construction was subjected to a projectile impact where ruptures were observed below the initial projectile impact, e.g., layers 1, 2, 6 and 15 of Gorilla® Glass ruptured while layers 3 to 5 and 7 to 14 remained intact. These ruptures were attributed to a failure wave which was generated when the impact projectile exceeded the speed of sound.

Lack of material densification allows an increased level of damage tolerance compared to materials with densification properties. Additionally, the use of different levels of chemical strengthening may also increase threat level improvements owing to the increased surface strength obtained by increasing or varying surface compression of a structure from 400 MPa to 1200 MPa in similar or different layer combinations.

The use of non-ion exchanged glass or compositions such as EagleXG have also shown BRG capabilities resulting in relatively clear compositions even after multiple ballistic shots. In some embodiments, the use of chemically strengthened laminations has been shown to exhibit the property of being opaque after the initial shot. This is an advantage for security vehicles or areas requiring a reduction in visibility on the witness side of the BRG window when under ballistic attack. In one experiment, it was observed that standard BRG remains clear after an initial ballistic impact while an exemplary 20 layer Gorilla® Glass laminate became optically opaque after an initial 9 mm ballistic impact with only two layers rupturing. This instant first shot opaqueness property can be incorporated into standard BRG constructions by adding one or more Gorilla glass layers into the composite. When placed on the front, these layers, when ruptured, provide a level of opaqueness. The level of opaqueness can be changed by either altering the number of Gorilla glass layers or reducing the Gorilla glass thickness or both.

In other embodiments, varying surface compression in the CS glass in different layers of the laminate may also allow the flexibility of glass layer composites to be adjusted to maximize the rejection and energy spread of a projectile. Unlike current glasses employed for BRG constructions, e.g., low iron or soda-lime glass, CS glass can flex and is not brittle. Such a property provides cushioning by flexing and springing back upon projectile impact. Hard and soft interlayers of various thicknesses from 0.3 mm to 5 mm may also help isolate thin CS glass layers, especially on the strike face of a structure. In some embodiments, thin CS glass with no strengthening may be employed as a thin anti-spall layer. The compression stress and internal tension thereof can be modified to provide no spall or to provide very fine spall with reduced hazards level on the witness side.

The bulk stiffness of the BRG composite with an all Gorilla® Glass structure was found to be a major factor when examining the performance against ballistic impact. An improvement in performance was observed when the total layers of an exemplary reached approximately 20 glass layers, i.e., 20 layers of 1 mm Gorilla glass with 19 layers of 0.76 mm PVB.

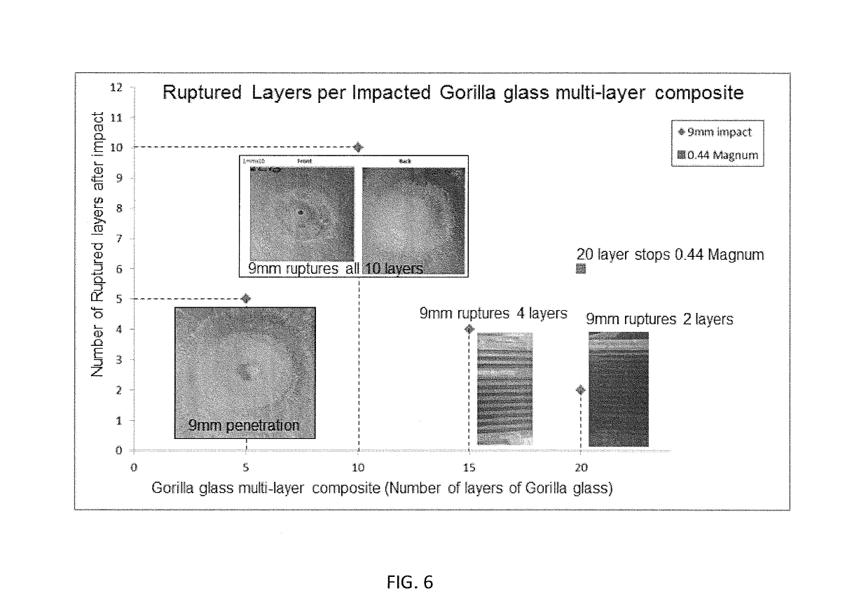

FIG. 6 is a graphical illustration comparing ballistic impact resistances of embodiments of the present disclosure. With reference to FIG. 6, a graph is provided illustrating that a ballistic impact resistance occurs when the total glass layers in some embodiments approach 20. It was discovered that an exemplary 20 layer structure possesses an increased rigidity and bulk stiffness that easily repels the energy deposited by a 9 mm impact and also a .44 caliber Magnum. A 5 layer 1 mm Gorilla® Glass structure does not appear to provide adequate protection to a 9 mm impact, while an exemplary 20 layer structure easily protects with only 2 layers rupturing.

Embodiments of the present disclosure may provide improved clarity (i.e., reduction of yellow/green discoloration) of lamination depending upon the use of clear interlayers (such as SentryGlas N-UV, or Solutia PVB AG series of interlayers) and/or CS glass layers. Exemplary CS glass thicknesses for embodiments depicted in FIGS. 1-3 may be from 0.4 mm to 3 mm thick, with preferred thicknesses being 0.5 to 1.1 mm. It should be noted that the thinnest current BRG glass layer constructions using soda lime glass possess glass layer thicknesses of greater than 3 mm each and are not as strong or impact resistant as a 1 mm fully strengthened CS glass layer. The additional strength provided by CS glass may result in embodiments of the present disclosure having an all CS glass lamination construction or in embodiments having a thinner CS glass lamination as the strike face of an existing BRG construction to increase deformation of a projectile resulting in additional absorbed energy in the structure lateral lattice rather than propelling the projectile further into the structure and resulting in additional normal incident lattice penetration. Further, the use of a thinner CS glass lamination for the strike face of an existing BRG construction with polycarbonate BRG may result in a thinner and lighter product, reduce or eliminate green/yellow discoloration of a product, reduce visual distortions, and/or increase the threat level capability of the enhanced product.

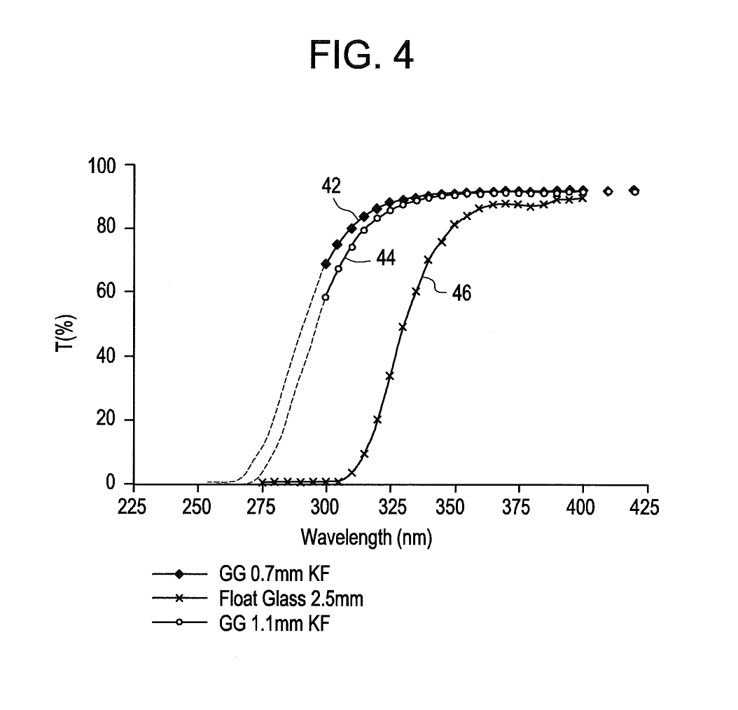

Clarity of exemplary laminations may be demonstrated by examining total light transmission per wavelength on materials or combinations of material. FIG. 4 is a graphical illustration comparing the transparency of Corning Gorilla® Glass to soda lime glass. With reference to FIG. 4, the percentage of light transmitted (T) through Corning Gorilla® Glass to the percentage of light transmitted (T) through conventional soda-lime glass is exhibited. Both the Corning Gorilla® Glass 0.7 mm layer 42 and 1.1 mm layer 44 exhibit significantly higher clarity in comparison to conventional soda lime glass 46.

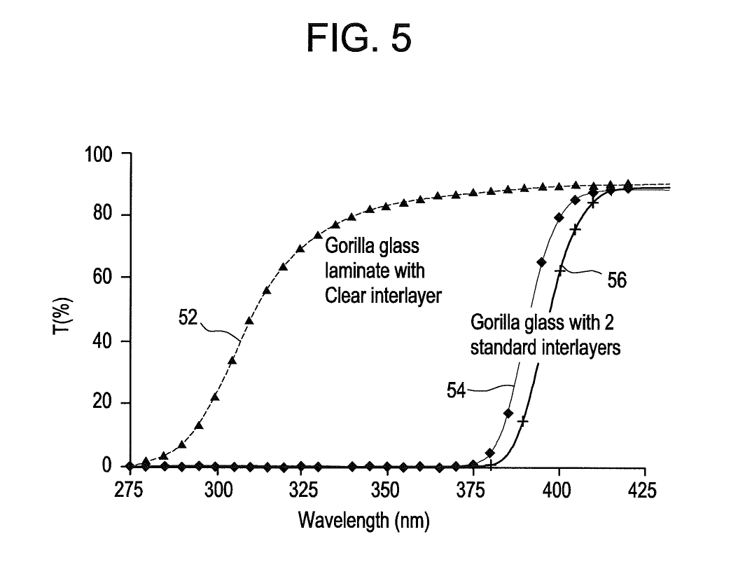

FIG. 5 is a graphical illustration comparing the transparency of Corning Gorilla® Glass laminated with transparent PVB interlayers to Corning Gorilla® Glass laminated with standard PVB interlayers. With reference to FIG. 5, use of transparent or clear polymeric interlayer material between layers of CS glass to provide superior clarity is illustrated in comparison to the use of a standard interlayer material. For example, a laminate having Corning Gorilla Glass with a clear interlayer 52 provides the most optically clear lamination in comparison to laminates having Corning Gorilla® Glass with standard interlayers 54, 56. The laminates having Corning Gorilla® Glass with standard interlayers 54, 56 illustrate cut-offs near 380 nm thereby providing near, optically-clear laminations. The laminate having Corning Gorilla® Glass with a clear interlayer 52 provides a transmission level flat-lined to 900 nm indicating that no color results from the short (>400 nm) to the longer wavelengths, while the standard interlayers 54, 56 produce the lightest of yellow tints owing to a slight reduction of transmission at the shorter wavelengths (>400 nm). This slight yellowing color is difficult to visually detect even with a bright white light backing. It should be noted, however, that the clarity of the laminates having Corning Gorilla® Glass with standard interlayers 54, 56 still exhibited far superior transparencies to float soda lime glass.

While this description may include many specifics, these should not be construed as limitations on the scope thereof, but rather as descriptions of features that may be specific to particular embodiments. Certain features that have been heretofore described in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and may even be initially claimed as such, one or more features from a claimed combination may in some cases be excised from the combination, and the claimed combination may be directed to a subcombination or variation of a subcombination.

Similarly, while operations are depicted in the drawings or figures in a particular order, this should not be understood as requiring that such operations be performed in the particular order shown or in sequential order, or that all illustrated operations be performed, to achieve desirable results. In certain circumstances, multitasking and parallel processing may be advantageous.

As shown by the various configurations and embodiments illustrated in FIGS. 1-5, various embodiments for multi-layer transparent light-weight safety glazings have been described.

While preferred embodiments of the present disclosure have been described, it is to be understood that the embodiments described are illustrative only and that the scope of the invention is to be defined solely by the appended claims when accorded a full range of equivalence, many variations and modifications naturally occurring to those of skill in the art from a perusal hereof.

1. A laminate structure comprising:
(a) a plurality of glass layers; and
(b) at least one polymer interlayer intermediate adjacent glass layers,
wherein each of the plural glass layers comprise thin, chemically strengthened or annealed glass.

2. The laminate structure of claim 1 further comprising a polycarbonate layer on a first side of the laminate structure.

3. The laminate structure of claim 2 further comprising a thin chemically strengthened glass layer on a second side of the laminate structure, the second side opposing the first side.

4. The laminate structure of claim 1 further comprising a thin chemically strengthened glass layer on a first side of the laminate structure.

5. The laminate structure of claim 1 wherein the polymer interlayer comprises a material selected from the group consisting of poly vinyl butyral (PVB), polycarbonate, acoustic PVB, ethylene vinyl acetate (EVA), thermoplastic polyurethane (TPU), ionomer, a thermoplastic material, and combinations thereof.

6. The laminate structure of claim 1 wherein each of the plural glass layers have a thickness selected from the group consisting of a thickness not exceeding 1.5 mm, a thickness not exceeding 1.0 mm, a thickness not exceeding 0.7 mm, a thickness not exceeding 0.5 mm, a thickness within a range from about 0.5 mm to about 1.0 mm, a thickness from about 0.5 mm to about 0.7 mm.

7. The laminate structure of claim 1 wherein the thicknesses of two adjacent glass layers are different.

8. The laminate structure of claim 1 wherein the composition of two adjacent glass layers are different.

9. The laminate structure of claim 1 further comprising at least twenty glass layers and nineteen polymer interlayers intermediate adjacent glass layers.

10. The laminate structure of claim 1 wherein a portion of the structure becomes optically opaque upon impact.

11. A glass laminate structure comprising:
(a) a plurality of chemically strengthened or annealed glass sheets;
(b) one or more polymeric interlayers positioned between adjacent chemically strengthened or annealed glass sheets; and
(c) a thin chemically strengthened glass sheet on a first side of the glass laminate structure.

12. The glass laminate structure of claim 11 further comprising a polycarbonate layer on a second side of the glass laminate structure, the second side opposing the first side.

13. The glass laminate structure of claim 11 wherein the polymeric interlayer comprises a material selected from the group consisting of poly vinyl butyral (PVB), polycarbonate, acoustic PVB, ethylene vinyl acetate (EVA), thermoplastic polyurethane (TPU), ionomer, a thermoplastic material, and combinations thereof.

14. The glass laminate structure of claim 11 wherein each of the plural glass sheets have a thickness selected from the group consisting of a thickness not exceeding 1.5 mm, a thickness not exceeding 1.0 mm, a thickness not exceeding 0.7 mm, a thickness not exceeding 0.5 mm, a thickness within a range from about 0.5 mm to about 1.0 mm, a thickness from about 0.5 mm to about 0.7 mm.

15. The glass laminate structure of claim 11 wherein the thicknesses of two adjacent glass sheets are different.

16. The glass laminate structure of claim 11 wherein the composition of two adjacent glass sheets are different.

17. The glass laminate structure of claim 11 further comprising at least twenty chemically strengthened or annealed glass sheets and nineteen polymeric interlayers positioned between adjacent chemically strengthened or annealed glass sheets.

18. The glass laminate structure of claim 11 wherein a portion of the structure becomes optically opaque upon impact.

19. A multi-layer glass structure comprising:
(a) n layers of chemically strengthened or annealed glass; and
(b) n−1 layers of a polymer interlayer,
wherein n is a positive integer greater than 2.

20. The multi-layer glass structure of claim 19 wherein n is selected from the group consisting of 5, 10, 15, 20.

21. The multi-layer glass structure of claim 19 further comprising a polycarbonate layer on a first side of the multi-layer structure.

22. The multi-layer glass structure of claim 21 further comprising a thin chemically strengthened glass layer on a second side of the multi-layer structure, the second side opposing the first side.

23. The multi-layer glass structure of claim 19 further comprising a thin chemically strengthened glass layer on a first side of the multi-layer structure.

24. The multi-layer glass structure of claim 19 wherein the polymer interlayer comprises a material selected from the group consisting of poly vinyl butyral (PVB), polycarbonate, acoustic PVB, ethylene vinyl acetate (EVA), thermoplastic polyurethane (TPU), ionomer, a thermoplastic material, and combinations thereof.

25. The multi-layer glass structure of claim 19 wherein each of the n layers of chemically strengthened or annealed glass have a thickness selected from the group consisting of a thickness not exceeding 1.5 mm, a thickness not exceeding 1.0 mm, a thickness not exceeding 0.7 mm, a thickness not exceeding 0.5 mm, a thickness within a range from about 0.5 mm to about 1.0 mm, a thickness from about 0.5 mm to about 0.7 mm.

26. The multi-layer glass structure of claim 19 wherein the thicknesses of two adjacent glass layers are different.

27. The multi-layer glass structure of claim 19 wherein the composition of two adjacent glass layers are different.

28. The multi-layer glass structure of claim 19 wherein a portion of the structure becomes optically opaque upon impact.
